(19) United States
(12) Patent Application Publication
(10) Pub. No.: US 2015/0068667 A1
(43) Pub. Date: Mar. 12, 2015

(54) MOLDING DEVICE AND MOLDING METHOD OF PNEUMATIC TIRE

(71) Applicant: TOYO TIRE & RUBBER CO., LTD., Osaka-shi (JP)

(72) Inventor: Syuuichi Nishikawa, Osaka-shi (JP)

(21) Appl. No.: 14/484,027

(22) Filed: Sep. 11, 2014

(30) Foreign Application Priority Data
Sep. 11, 2013 (JP) 2013-188174

(51) Int. Cl. B29D 30/00

(52) U.S. Cl. CPC B29D 30/0016; B29D 2030/0038
USPC 156/117; 156/397

(57) ABSTRACT

A pneumatic tire molding device includes an extruder which mixes and discharges a rubber material, a mouth piece which is attached to a leading end of the extruder, and a rotary support body around which a rubber strip discharged out of a discharge port of the mouth piece is wound, wherein a receiving portion is formed in the mouth piece closer to a rear side in a rotating direction of the rotary support body than the discharge port in an end surface facing to a rotation surface of the rotary support body, the receiving portion being capable of receiving the rubber strip which has been already wound around the rotary support body.

### BACKGROUND OF THE INVENTION

1. Field of the Invention

The present invention relates to a molding device and a molding method for molding a pneumatic tire by winding a rubber strip discharged from a mouth piece attached to a leading end of an extruder around a rotary support body.

2. Description of the Related Art

As shown in FIG. 9, the pneumatic tire is constructed by combining various rubber members such as side wall rubbers 7, a tread rubber 8 and an inner liner rubber 9.

As a method of molding these rubber members, there has been known a so-called strip build method which molds a rubber member by winding a ribbon-like rubber strip in a circumferential direction (for example, the following Patent Documents 1 and 2). According to the strip build method mentioned above, a rubber member having a desired cross sectional shape can be molded by winding the rubber strip around a rotary support body such as a molding drum and sequentially laminating the rubber strip.

The following Patent Document 3 describes a tire molding method which winds a ribbon-like rubber strip S without inclining in a tire circumferential direction in the first one lap M₁ in a winding start side, winds the ribbon-like rubber strip S while inclining in relation to the tire circumferential direction so as to apply a predetermined pitch feed in a tire width direction within a partial area in the tire circumferential direction in each of laps M₂ to Mₙ₋₁ after the second lap and without inclining in the tire circumferential direction in the other portions, and further winds the ribbon-like rubber strip S without inclining in the tire circumferential direction in the last one lap Mₙ in a winding end side, as shown in FIG. 4.

In the meantime, in the strip build method mentioned above, since a mouth piece 13 is moved close to a molding drum 2 at the end of the winding, the mouth piece 13 comes into contact with the rubber strip S which has been already wound around the molding drum 2 and crushes the rubber strip S, and a radial force variation (RFV) and a radial runout (RRO) of tire are increased, thereby causing deterioration of a high-speed durability.

### PRIOR ART DOCUMENT

### Patent Document

Patent Document 1: JP-A-2002-178415

Patent Document 2: JP-A-2002-205512

Patent Document 3: JP-A-2009-119824

### SUMMARY OF THE INVENTION

The present invention is made by taking the actual condition mentioned above into consideration, and an object of the present invention is to provide a molding device and a molding method which can mold a pneumatic tire suppressing increase of the RFV and the RRO and improving a high-speed durability.

The object can be achieved by the following present invention. That is, the present invention provides a pneumatic tire molding device includes an extruder which mixes and discharges a rubber material, a mouth piece which is attached to a leading end of the extruder, and a rotary support body around which a rubber strip discharged out of a discharge port of the mouth piece is wound, wherein a receiving portion is formed in the mouth piece closer to a rear side in a rotating direction of the rotary support body than the discharge port in an end surface facing to a rotation surface of the rotary support body, the receiving portion being capable of receiving the rubber strip which has been already wound around the rotary support body.

In the mouth piece of the molding device of the pneumatic tire according to the present invention, the receiving portion which can receive the rubber strip already wound around the rotary support body is formed closer to the rear side in the rotating direction of the rotary support body than the discharge port in the end surface facing to the rotation surface of the rotary support body. As a result, even in the case that the mouth piece is moved close to the rotary support body at the end of the winding, the end surface of the mouth piece does not come into contact with the rubber strip which has been already wound around the rotary support body and does not crush the rubber strip. As a result, since the desired cross sectional shape can be obtained even at the position where the winding is finished, it is possible to mold the pneumatic tire suppressing increase of the RFV and the RRO and improving a high-speed durability.

In the molding device of the pneumatic tire according to the present invention, a cross section of the receiving portion is preferably larger than a cross section of the rubber strip. Since the receiving portion can completely receive the rubber strip in the case that the cross section of the receiving portion is larger than the cross section of the rubber strip, the end surface of the mouth piece does not crush the rubber strip.

In the molding device of the pneumatic tire according to the present invention, a cross section of the receiving portion is preferably formed into a rectangular shape in which the maximum thickness and the maximum width of the rubber strip are respectively set to a short side and a long side. According to the structure, it is possible to receive ups and downs of the rubber member to be molded.

Moreover the present invention provides a pneumatic tire molding method of molding a pneumatic tire by winding a rubber strip around a rotary support body, the rubber strip being discharged from a discharge port of a mouth piece which is attached to a leading end of an extruder, wherein an end surface of the mouth piece facing to a rotation surface of the rotary support body is moved closer to the rotary support body at the end of the winding, and the rubber strip which has been already wound around the rotary support body is received in a receiving portion which is formed closer to a rear side in a rotating direction of the rotary support body than the discharge port in an end surface of the mouth piece.

According to the structure, since the rubber strip is received in the receiving portion formed in the end surface of the mouth piece even in the case that the mouth piece is moved close to the rotary support body at the end of the winding, the end surface of the mouth piece does not come into contact with the rubber strip which has been already wound around the rotary support body and does not crush the rubber strip. As a result, since the desired cross sectional shape can be obtained even at the position in which the winding is finished, it is possible to mold the pneumatic tire suppressing increase of the RFV and the RRO and improving a high-speed durability.

### BRIEF DESCRIPTION OF THE DRAWINGS

FIG. 1 is a cross sectional view schematically showing an example of a molding device of a pneumatic tire according to the present invention;

FIG. 2 is a cross sectional view of a rubber strip;

FIG. 3 is a front elevational view and a side elevational view of a mouth piece;

FIG. 4 is a front elevational view for describing a winding state of the rubber strip;

FIG. 5 is a cross sectional view along line A-A and a cross sectional view along line B-B in FIG. 4 in the case of using the mouth piece according to the present invention;

FIG. 6 is a cross sectional view along line A-A and a cross sectional view along line B-B in FIG. 4 in the case of using a conventional mouth piece;

FIG. 7A is a front elevational view and a side elevational view of a mouth piece according to the other embodiment;

FIG. 7B is a front elevational view and a side elevational view of a mouth piece according to the other embodiment;

FIG. 7C is a front elevational view and a side elevational view of a mouth piece according to the other embodiment;

FIG. 7D is a front elevational view and a side elevational view of a mouth piece according to the other embodiment;

FIG. 8 is a front elevational view of a mouth piece according to the other embodiment; and

FIG. 9 is a tire meridian cross sectional view showing an example of the pneumatic tire.

### DETAILED DESCRIPTION OF THE PREFERRED EMBODIMENTS

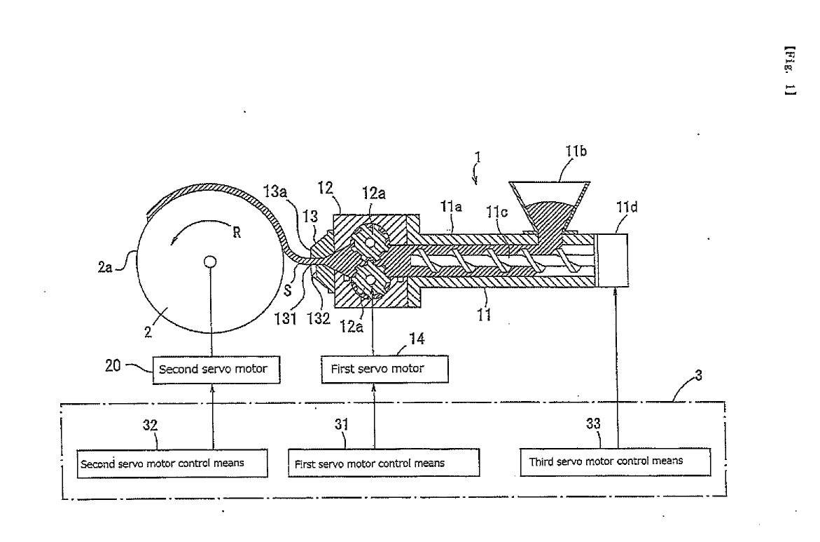

A description will be given below of embodiments according to the present invention with reference to the accompanying drawings. FIG. 1 is a cross sectional view schematically showing an example of a molding device of a pneumatic tire according the present invention. The molding device is provided with an extruding device 1, a molding drum 2 (corresponding to a rotary support body of the present invention) around which a rubber strip S discharged out of the extruding device 1 is wound, and a control device 3.

The extruding device 1 is provided with an extruder 11 which mixes and discharges a rubber material, a gear pump 12 which is connected to a leading end side in an extruding direction of the extruder 11, and a mouth piece 13 which is connected to the leading end side. The extruder 11 has a cylindrical barrel 11a, a hopper 11b which is connected to a supply port of the barrel 11a, a screw 11c which mixes the rubber material so as to discharge it to a leading end side, and a third servo motor 11d which serves as a drive unit rotationally driving the screw 11c. A rotating speed of the third servomotor 11d is controlled by a third servo motor control means 33 which the control unit 3 has.

The gear pump 12 has a pair of gears 12a, and has a function of discharging the rubber material to an outlet side toward the mouth piece 13. Each of the gears 12a is rotationally driven by a first servo motor 14, and rotating speeds of the gears 12a are controlled by a third servo motor control means 31 which the control unit 3 has.

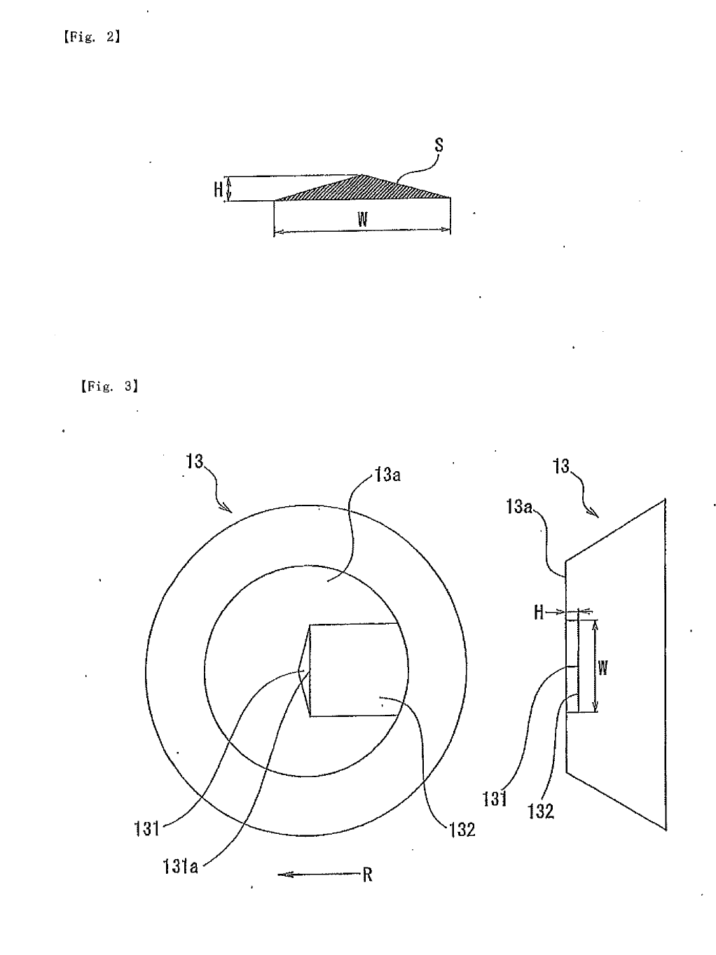

The mouth piece 13 has a discharge port 131 having a predetermined shape, and the rubber material supplied to the mouth piece 13 from the gear pump 12 is continuously extrusion molded in the form of a rubber strip S having a predetermined cross sectional shape. The rubber strip S is formed into a ribbon shape with a small width and a small thickness, and various sizes of rubber strips are employed in correspondence to kinds of the tire. Further, a cross sectional shape of the rubber strip S is not limited to a particular shape, but can employ various shapes in correspondence to a finished cross sectional shape, for example, an approximately triangular shape, an approximately crescent shape and an approximately trapezoidal shape. The cross sectional shape of the rubber strip S of the present embodiment is formed approximately into the triangular shape as shown in FIG. 2.

The molding drum 2 is structured such as to be rotatable in a direction R by a second servo motor 20. A rotating speed of the second servo motor 20 is controlled by a second servo motor control means 32 which the control unit 3 has. The rubber strip S which has been extrusion molded via the mouth piece 13 is directly supplied to the molding drum 2, and the rubber strip S can be wound along a circumferential direction by rotationally driving the molding drum 2 in the direction R in a state in which the rubber strip S is attached to the molding drum 2.

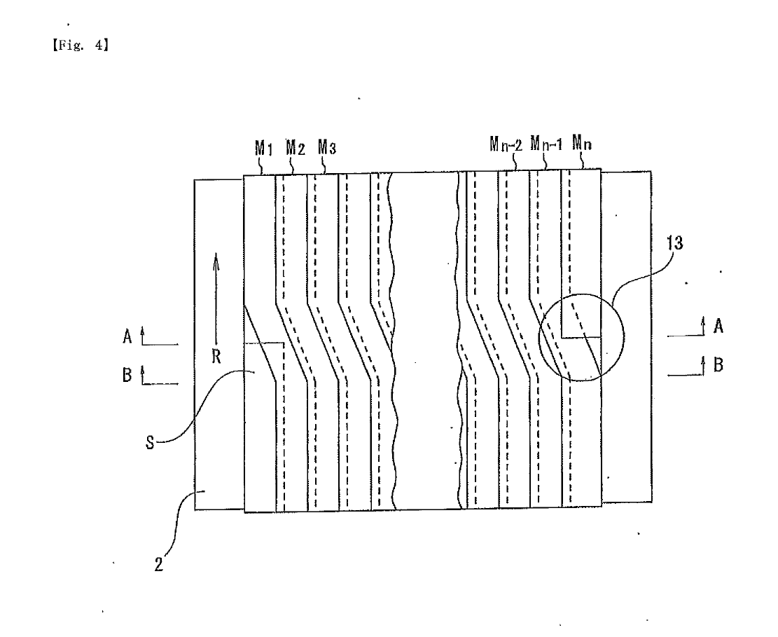

The molding drum 2 is structured such that the molding drum 2 can reciprocate in an axial direction (a vertical direction to the paper surface in FIG. 1) by a drive unit (not shown), and the reciprocating motion can be controlled by the control unit 3. A rubber member having a desired cross sectional shape can be molded by spirally winding the rubber strip S on the basis of a relative movement of the rotating molding drum 2 in the axial direction in relation to the extruding device 1, or winding the rubber strip S while applying a feed in predetermined pitches within a partial area in a tire circumferential direction as shown in FIG. 4. On the other hand, the extruding device 1 is structured such as to be movable back and forth in the extruding direction by a drive unit (not shown), and the movement is controlled by the control unit 3.

FIG. 3 shows a front elevational view and a side elevational view of the mouth piece 13. The mouth piece 13 constructing the molding device according to the present invention is formed approximately into a circular cone shape, and has an end surface 13a which faces to a rotation surface 2a of the molding drum 2. A discharge port 131 is provided approximately in a center portion of the end surface 13a of the mouth piece 13. The discharge port 131 is formed into an approximately triangular shape, an approximately crescent shape or an approximately trapezoidal shape in correspondence to the cross sectional shape of the rubber strip S, and can mold the rubber material into the ribbon-like rubber strip S having a cross sectional shape in correspondence to the shape of the discharge port 131. The discharge port 131 of the present embodiment is formed into an approximately flat triangular shape.

A receiving port 132 is formed in the end surface 13a of the mouth piece 13 closer to a rear side in a rotating direction R of the molding drum 2 than the discharge port 131. As a result, the receiving port 132 can receive the rubber strip S which has been already wound around the molding drum 2.

The receiving portion 132 of the present embodiment is formed its cross section into a rectangular shape. Further, the receiving portion 132 of the present embodiment forms a concave portion which continuously extends in the same cross section from an edge portion 131a of the discharge port 131 toward a rear side in the rotating direction R.

A cross section of the receiving portion 132 is larger than a cross section of the rubber strip S, and the receiving portion 132 can completely receive the rubber strip S without contact of the rubber strip S with a bottom surface and a side surface of the receiving portion 132. In the present embodiment, a cross section of the receiving portion 132 is a rectangular shape in which the maximum thickness H and the maximum width W of the rubber strip S are respectively set to a short side and a long side.

A molding method of a pneumatic tire according to the present invention is a pneumatic tire molding method of molding the pneumatic tire by winding the rubber strip S around the molding drum 2, the rubber strip S being discharged from the discharge port 131 of the mouth piece 13 which is attached to the leading end of the extruder 11, wherein the end surface 13a of the mouth piece 13 facing to the rotation surface 2a of the molding drum 2 is moved closer to the molding drum 2 at the end of the winding, and the rubber strip S which has been already wound around the molding drum 2 is received in the receiving portion 132 which is formed closer to the rear side in the rotating direction R of the molding drum 2 than the discharge port 131 in the end surface 13a of the mouth piece 13.

A description will be given of a case that a rubber member having a desired cross sectional shape is molded by winding the rubber strip S around the molding drum 2, as shown in FIG. 4. FIG. 6 is a cross sectional view along line A-A and a cross sectional view along line B-B in FIG. 4 in the case that the receiving portion 132 is not formed in the end surface 13a of the mouth piece 13. In this case, in the case that the mouth piece 13 is moved close to the molding drum 2, at the end of the winding, the end surface 13a of the mouth piece 13 comes into contact with the rubber strip S which has been already wound around the molding drum 2 and crushes the rubber strip S, and the rubber member does not forma desired cross sectional shape as shown in the cross sectional view along line B-B.

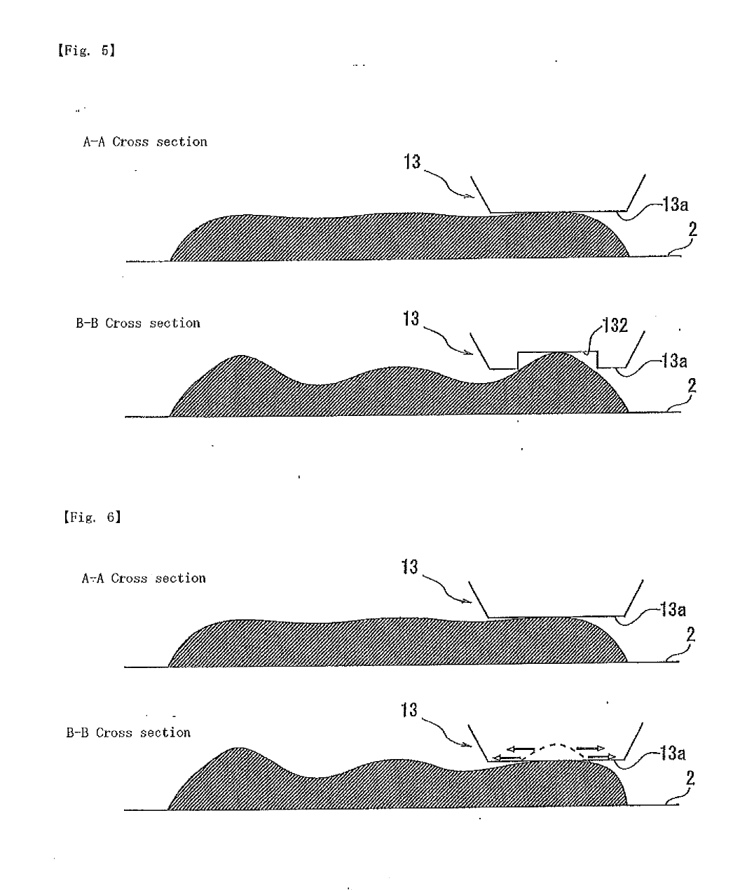

On the other hand, FIG. 5 is a cross sectional view along line A-A and a cross sectional view along line B-B in FIG. 4 in the case that the receiving portion 132 is formed in the end surface 13a of the mouth piece 13 like the present invention. According to the present invention, since the rubber strip S is received in the receiving portion 132 even in the case that the mouth piece 13 is moved close to the molding drum 2 at the end of the winding, the end surface 13a of the mouth piece 13 does not come into contact with the rubber strip S which has been already wound around the molding drum 2 and does not crush the rubber strip S. As a result, since a desired cross sectional shape can be obtained even at the position where the winding is finished, it is possible to mold the pneumatic tire suppressing increase of the RFV and the RRO and improving a high-speed durability.

### OTHER EMBODIMENT

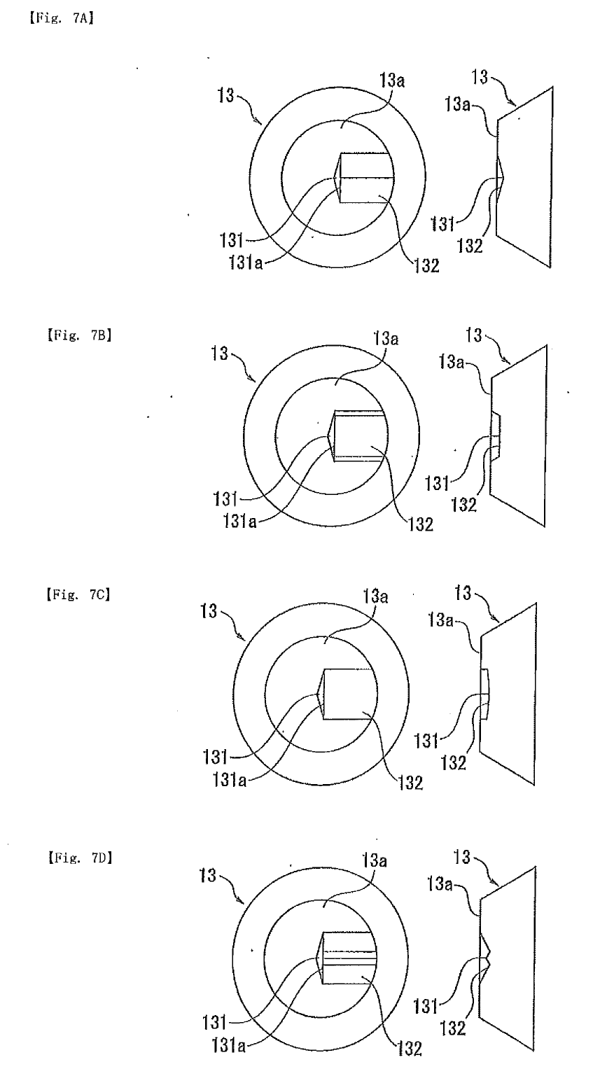

(1) In the embodiment mentioned above, the cross section of the receiving portion 132 is formed into the rectangular shape; however, it is not limited to this. For example, the cross section of the receiving portion 132 may be formed into a triangular shape as shown in FIG. 7A. At this time, the cross sectional shape of the receiving portion 132 is approximately the same as the shape of the discharge port 131. Since the rubber strip S discharged out of the discharge port 131 inflates, it is preferable that the cross sectional shape of the receiving portion 132 is larger than the shape of the discharge port 131. An influence applied to a rubber flow in the edge portion 131a of the discharge port 131 can be reduced by forming the cross section of the receiving port 132 into the triangular shape. As a result, it is possible to make the shape change at the discharging time of the rubber strip S small.

Further, the cross section of the receiving portion 132 maybe formed into a trapezoidal shape as shown in FIG. 7B, and the cross section of the receiving portion 132 may be formed into a circular arc shape in its bottom surface as shown in FIG. 7C. As a result, since the rubber flow in the edge portion 131a of the discharge port 131 is improved, the discharge amount of the rubber strip S is increased and disconnection in the member end is hardly generated, and it is possible to receive ups and downs of the molded rubber member.

Further, the cross section of the receiving portion 132 maybe constructed by a plurality of triangular shapes as shown in FIG. 7D. As a result, it is possible to stabilize the cross sectional shape of the rubber strip S in correspondence to the shape of the discharge port 131, and it is possible to receive the ups and downs of the molded rubber member.

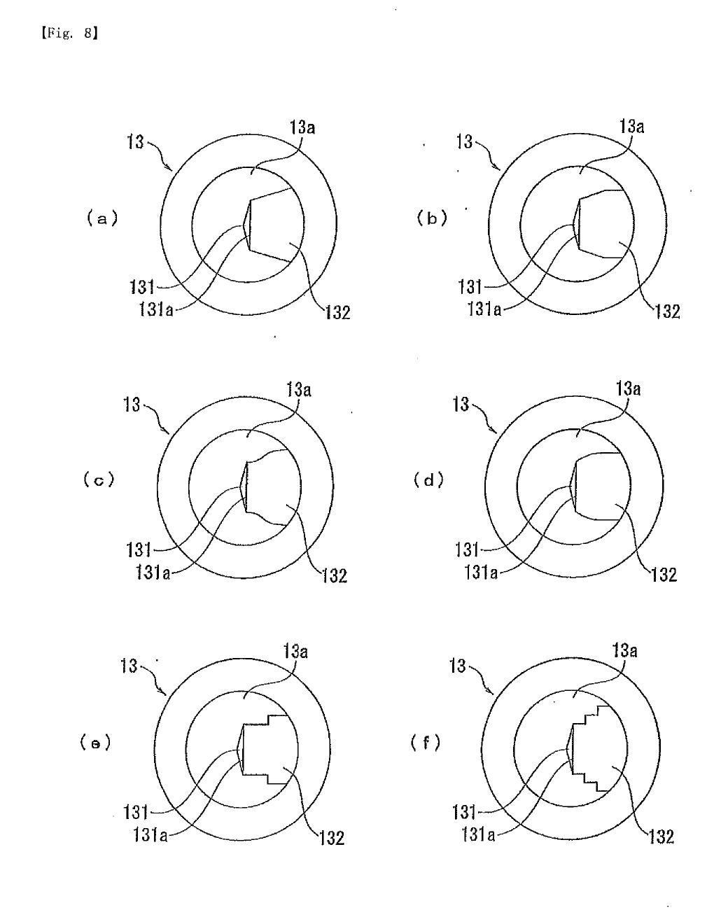

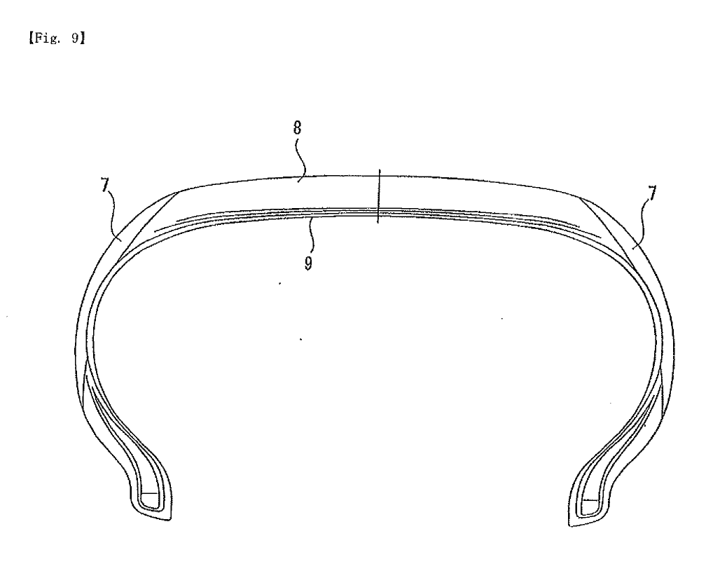

(2) In the embodiment mentioned above, the receiving portion 132 forms the concave portion which continuously extends from the edge portion 131a of the discharge port 131 toward the rear side in the rotating direction R with the same cross section; however, the cross section of the receiving portion 132 may be changed along the rotating direction R. FIGS. 8A to 8F show examples in which a width of the cross section of the receiving portion 132 is widened toward the rear side in the rotating direction R. The receiving portions 132 shown in FIGS. 8A to 8F can correspond to the ups and downs of the rubber member in a wider range in comparison with the receiving portion 132 shown in FIG. 3.

(3) In the embodiment mentioned above, the description is given of the method of molding the rubber member having the desired cross sectional shape by winding the rubber strip S while applying the feed at the predetermined pitch in the partial area in the tire circumferential direction as shown in FIG. 4; however, the molding device and the molding method of the present invention can be applied to a case that a rubber member having a desired cross sectional shape is molded by spirally winding the rubber strip S.

What is claimed is:

1. A pneumatic tire molding device comprising:
an extruder which mixes and discharges a rubber material;
a mouth piece which is attached to a leading end of the extruder; and
a rotary support body around which a rubber strip discharged out of a discharge port of the mouth piece is wound,
wherein a receiving portion is formed in the mouth piece closer to a rear side in a rotating direction of the rotary support body than the discharge port in an end surface facing to a rotation surface of the rotary support body, the receiving portion being capable of receiving the rubber strip which has been already wound around the rotary support body.

2. The pneumatic tire molding device according to claim 1, wherein a cross section of the receiving portion is larger than a cross section of the rubber strip.

3. The pneumatic tire molding device according to claim 1, wherein a cross section of the receiving portion is formed into a rectangular shape in which the maximum thickness and the maximum width of the rubber strip are respectively set to a short side and a long side.

4. A pneumatic tire molding method of molding a pneumatic tire by winding a rubber strip around a rotary support body, the rubber strip being discharged from a discharge port of a mouth piece which is attached to a leading end of an extruder,
wherein an end surface of the mouth piece facing to a rotation surface of the rotary support body is moved closer to the rotary support body at the end of the winding, and the rubber strip which has been already wound around the rotary support body is received in a receiving portion which is formed closer to a rear side in a rotating direction of the rotary support body than the discharge port in an end surface of the mouth piece.
